(19) United States
(12) Patent Application Publication
(10) Pub. No.: US 2012/0297424 A1
(43) Pub. Date: Nov. 22, 2012

(54) PROXY DIGITAL VIDEO RECORDER

(75) Inventors: Kulvir S. Bhogal, Pflugerville, TX (US); Gregory J. Boss, Saginaw, MI (US); Rick A. Hamilton, II, Charlottesville, VA (US); Brian M. O'Connell, Cary, NC (US)

(73) Assignee: INTERNATIONAL BUSINESS MACHINES CORPORATION, Armonk, NY (US)

(21) Appl. No.: 13/110,801

(22) Filed: May 18, 2011

(51) Int. Cl. G06F 13/00; H04N 5/92

(52) U.S. Cl. 725/58; 386/326; 386/E05.009

(57) ABSTRACT

A computer-implemented proxy digital video recording system and method, including a processor and memory. The memory including program instructions that are executable by the processor to intercept a request to record a video program, the request triggered by a requesting user and having a request format. The proxy digital video recording system and method determines if a target digital video recorder can understand a format of the request, and translates the request into an intelligible format if the target digital video recorder cannot understand the request format.

### BACKGROUND

1. Field

This disclosure relates generally to digital video recorders, and, more particularly, to proxy-based digital video recording.

2. Background

Digital video recorders (“DVR”) and personal video recorders (“PVR”) are devices that record video to a disk drive or other storage medium for playback at a later time. These devices include, for example, standalone set-top recording devices and software programs for personal computers. Generally, these devices enable many enhancements to the broadcast video entertainment experience, such as time-shifting, pausing live television broadcasts, instant replay, “chasing” playback and the ability to skip advertisements.

### BRIEF SUMMARY

In one aspect of this disclosure, a computer-implemented proxy digital video recording system and method is disclosed, comprising a processor and memory. The memory comprises program instructions that are executable by the processor to intercept a request to record a video program, the request triggered by a requesting user and having a request format. The instructions are executable by the processor to determine if a target digital video recorder can understand a format of the request, and translate the request into an intelligible format if the target digital video recorder cannot understand the request format.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE SEVERAL VIEWS OF THE DRAWINGS

This disclosure is further described in the detailed description that follows, with reference to the drawings, in which:

FIG. 1 is a high-level representation of an illustrative proxy-based digital video recording system;

FIG. 2 is flow chart representing a preferred sequence of steps for implementing the proxy-based digital video recording system of FIG. 1;

FIG. 3 is flow chart representing an alternative preferred sequence of steps for implementing the proxy-based digital video recording system of FIG. 1;

FIG. 4 is flow chart representing a continuing preferred sequence of steps for implementing the proxy-based digital video recording system of FIG. 1; and

FIG. 5 is flow chart representing a continuing preferred sequence of steps for implementing the illustrative proxy-based digital video recording system of FIG. 1.

### DETAILED DESCRIPTION

This application discloses a proxy-based digital video recording system 100, which intermediates between digital video recorders and video providers. Subscription-based program providers often use proprietary command signal formats that are intelligible only by proprietary digital video recorder units associated with the program provider. The interposition of a proxy-based digital video recording system allows translation of the proprietary command signal formats. This may advantageously decouple proprietary digital video recorders from the video providers, thereby allowing users to schedule recording sessions on their digital video recorders regardless of which program provider issued the recording instruction. Additionally, this may also centralize organization of digital video recording by allowing a single unit to control sorting and scheduling of recordings on multiple (and potentially, diverse) digital video recorder units.

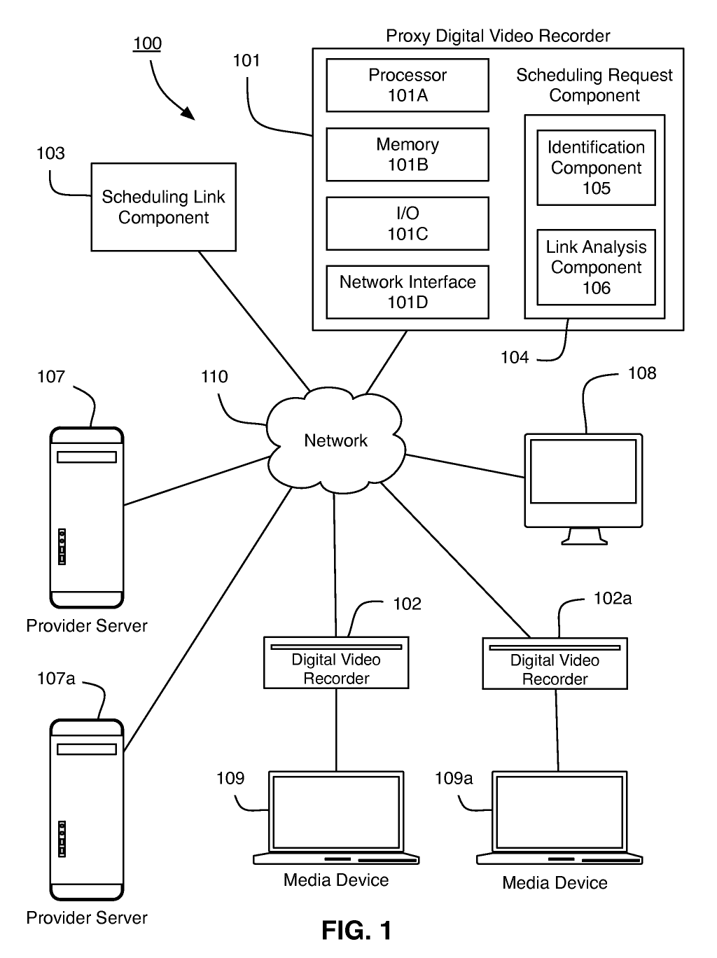

FIG. 1 is a high-level representation of an illustrative proxy-based digital video recording system 100. Network 110 may represent any aggregate network of computer or computer-implemented devices, such as (but not limited to) a local area network, wide area network, intranet, extranet, or preferably, the global Internet. Network 110 may operate concurrently on multiple mediums, including copper (such as Ethernet and coaxial enabled networks), fiber-optic (including fiber-to-the-node, fiber-to-the-curb, fiber-to-the-cabinet, fiber-to-the-last-amplifier, etc.), telephone network and wireless networks. Network 110 may allow intercommunication between non-local devices, such as (but not limited to) one or more user computers 108, proxy digital video recorder 101, one or more digital video recorders 102, 102a, and one or more program provider servers 107, 107a.

User computer 108 may represent a personal computer or personal computing device with Internet browsing functionality and a network connection. Such devices may include (but are not limited to) laptop computers, desktop computers, smart phones, touch-screen tablets and other such devices. Users may utilize user computer 108 to access programming schedules and program advertisements having hyperlinks, the selection of which may instruct proxy digital video recorder 101 to schedule digital video recording sessions.

Digital video recorders 102, 102a may represent one or more network-enabled media recorder devices associated with a user, including (but not limited to) digital video recorders and personal video recorders, operating within any desirable format, including set-top boxes, portable media players, and televisions with built-in recording functionality. Digital video recorder 102, 102a preferably includes a processor for executing instructions and supporting hardware components (i.e., random access memory), storage medium for storing data (including process instructions or digital media) and a network connection for sending and receiving communication data over network 110. Digital video recorder 102 may be implemented using any combination of hardware and/or software components, or alternatively, all hardware or all software components.

Scheduling link component 103 is preferably an embedded HTML hyperlink. Scheduling link component 103 may be embedded in any suitable location, such as (but not limited to) a web page. For example, it may be embedded in a web-based advertisement (preferably) for the program that is being promoted. Therefore, a user on, for example, user computer 108 that sees the advertisement for the program and wishes to record the program may click on or otherwise select the advertisement (or link within the advertisement) to schedule a recording for the promoted program. Alternatively, the scheduling link component 103 may be embedded on an Internet-enabled program guide for a network. For instance, link component 103 may be embedded on a schedule of programs and time slots. A user using, for example, user computer 108 may select the schedule entry for the program, triggering the link and automatically scheduling recording of the program. Other embodiments are also contemplated. For example, the link component 103 may be embedded on a program guide displayed on a media device 109, 109a, such as (but not limited to) a cable television program guide or a hotel television network program guide.

Scheduling link component 103 may take the form of a “directed” recording link that preferably includes detailed instructions for scheduling a recording, such as (but not limited to) broadcast start time, broadcast duration and station identification. Alternatively, a “descriptive” recording link may include a description of the recording, including information such as (but not limited to) media title, episode title/number (if applicable) or some unique identification code, if one has been implemented. In this embodiment, the proxy digital video recorder 101 would be responsible for searching through a media listing (such as a cable television electronic programming guide) to find the relevant program, and schedule a recording for it.

Proxy digital video recorder 101 preferably represents a computer-implemented system for scheduling, storing and converting digital video programming. Proxy digital video recorder 101 may be implemented using any combination of hardware and/or software components, or alternatively, all hardware or all software components. For example, proxy digital video recorder 101 may constitute pure software operating locally on one or more computer systems, such as user computer 108 or media device 109, 109a. Alternatively, proxy digital video recorder 101 may be implemented as a centralized web service, operating on one or more core servers located remotely on network 110.

Proxy digital video recorder 101 preferably includes a processor 101A for executing program instructions and processes, memory 101B for storing data and instructions, and a network interface device 101D for providing access to network 110. Additional components may be added as desired. For example, proxy digital video recorder 101 may include interface input/output (I/O) devices 101C for direct human interaction, such as (but not limited to) keyboard and mouse (and other input devices) along with one or more displays.

Proxy digital video recorder 101 preferably includes a scheduling request component 104. The scheduling request component 104 may be responsible for handling incoming requests to schedule a program for recording. Scheduling request component 104 preferably includes two subcomponents to perform this task. The first is preferably an identification component 105, which ascertains the identity of a requesting user scheduling a video recording. Conventional methods may be used to implement the identification component 105, such as prompting for a user name and password, or analyzing the requesting user's Internet protocol address and correlating it with a known pre-registered user. A “cookie” may be presented to the requesting user's web browser to enable a requesting user to schedule multiple recordings without necessitating re-identification for each operation. Information identifying the requesting user's digital video recorder unit 102, 102a may also be interpreted by the identification component 105. For example, the user may transmit to or otherwise provide the identification component 105 with the name of the user's digital video recorder service subscription (such as TiVo® and the serial number of the TiVo® digital video recorder). This information may enable the proxy digital video recorder 101 to determine what formats are understood by the digital video recorder unit 102 associated with the requesting user.

The second component of the scheduling request component 104 is preferably a link analysis component 106. Once a scheduling request has been received, the link analysis component 106 preferably validates the request. Validation may include ensuring the recording request is correct and uncorrupted. After the request has been validated, the request is preferably stored in memory within or otherwise associated with the proxy digital video recorder 101, thereby scheduling a recording for the requesting user. The link analysis component 106 may support both directed and descriptive link formats described above.

First and second video program providers 107 and 107a may represent servers owned and operated by video program providers, such as (but not limited to) cable or satellite television network providers. These may include servers operated by any provider entity from large aggregate providers of cable and satellite television (such as Time-Warner Cable®, Comcast®, Dish Network®, etc.) down to individual premium cable television networks (such as HBO®, Fox® and Starz®). The servers 107, 107a may be responsible for supporting broadcast scheduling information and issuing recording command signals for programs airing on the respective provider.

Media devices 109, 109a may represent television units, computers, hand-held players and other devices on which users may display video recorded digital video programming. Media device 109, 109a and user computer 108 may, in some embodiments, be the same device. Examples of this embodiment may include situations where users schedule downloads on a computer, and the recorded programs are later displayed on the same computer. Alternatively, they may be separate devices. Examples may include embodiments where users schedule recordings on their computer, which are ultimately downloaded to a digital video recorder, which in turn displays the recorded program on a television. Media device 109 is preferably operatively connected to the digital video recorder unit 102 to enable display of programs stored on digital video recorder unit 102 on media device 109. Similarly, media device 109a is preferably operatively connected to the digital video recorder unit 102a to enable display of programs stored on digital video recorder unit 102a on media device 109a. Alternatively, digital video recorder unit 102 and media device 109, and digital video recorder 102a and media device 109a may be connected only through network 110 (such as when media device 109 and user computer 108 are a single entity), in which case programs stored on digital video recorder 102 may be streamed over network 110 to media device 109.

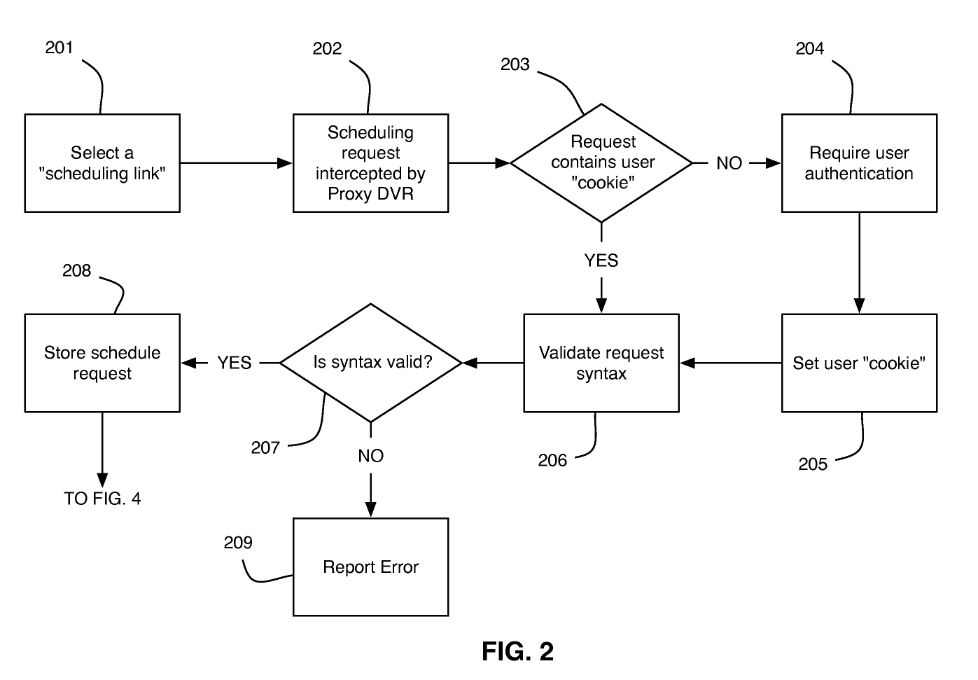

FIG. 2 is flow chart illustrating a preferred sequence of steps for implementing the proxy digital video recorder system 100. In step 201, a requesting user on, for example, user computer 108 may select a scheduling link component 103. As described above, scheduling link component 103 may be embedded as, for example, an advertisement promoting an associated video program, or an entry in a menu-driven television programming schedule. Users may, therefore, encounter the scheduling link component 103 by, for example, seeing an Internet advertisement for the program, or by browsing a network programming schedule on user computer 108. Users may then schedule a recording of the program by, for example, “mouse-click” selecting the advertisement or entry. Other implementations are also contemplated. For example, link component 103 may be embedded in an on-screen video program guide displayed on a television, such as a cable television menu-based directory or a hotel television program access system. A requesting user may indicate that the user wishes to schedule the program by navigating a highlighting cursor onto the appropriate entry and depressing a “select” button on the television remote control.

Selection of the link component 103 typically triggers a scheduling request to be sent to a proprietary digital video recorder from a provider server 107 or 107a. However, in step 202, proxy digital video recorder 101 may intercept or otherwise receive the scheduling request instead. This may be effected in a variety of ways. If proxy digital video recorder 101 is a software instance running on the local user computer 108, it may be set to automatically intercept any scheduling requests generated off a web page being viewed on the user computer 108. Alternatively, if proxy digital video recorder 101 is a physical device located remotely from user computer 108, it may be coupled to the actual digital video recorders 102 and 102a such that any scheduling requests sent to the digital video recorders 102 and 102a must first pass through proxy digital video recorder 101. Any other solutions may be utilized as appropriate.

Subsequently, in step 203, the proxy digital video recorder 101 (through identification component 105) may determine whether the schedule request information includes a user hypertext “cookie,” which preferably contains at least identifying information for the requesting user. If no “cookie” exists, then in step 204, the proxy digital video recorder 101 may send an authentication request over network 100 to the user computer 108 (or other network enabled media device). This may cause a prompt or notice to be displayed to user on the display of user computer 108, requiring (for example) input of a user name and password for the purposes of user authentication. Once the user submits the required information, a hypertext “cookie” may be set in step 205 (thereby storing user identification information for this session).

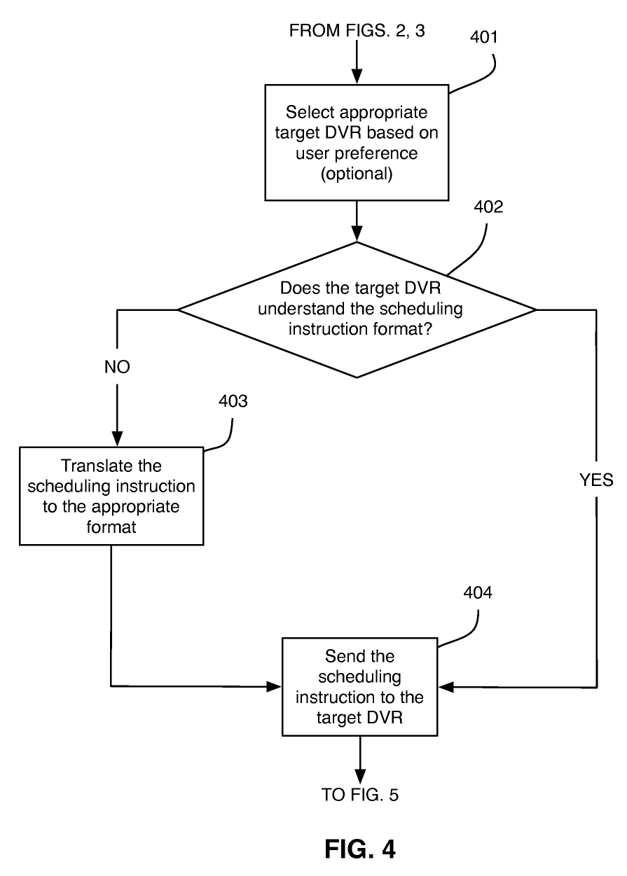

Once completed (or if the query from step 203 returned a positive result), then, in step 206, the proxy digital video recorder 101, through the link analysis component 106, may initiate a determination as to whether the syntax of the request is valid. In step 207, the link analysis component 106 may utilize any conventional method to determine whether the syntax is valid. For example, the proxy digital video recorder 101 may parse the information in the request packet to determine if any data corruption has occurred. Checksum, cyclical redundancy check, parity bits, and other known methods of error detection may also be utilized as required. If the syntax is incorrect, then in step 209, the proxy digital video recorder 101 preferably reports an error over network 110 to the requesting user's computer 108 for display to the requesting user. If the syntax is correct, then, in step 208, proxy digital video recorder 101 preferably stores the schedule request (in association with the requesting user) and progresses to FIG. 4 (discussed further below).

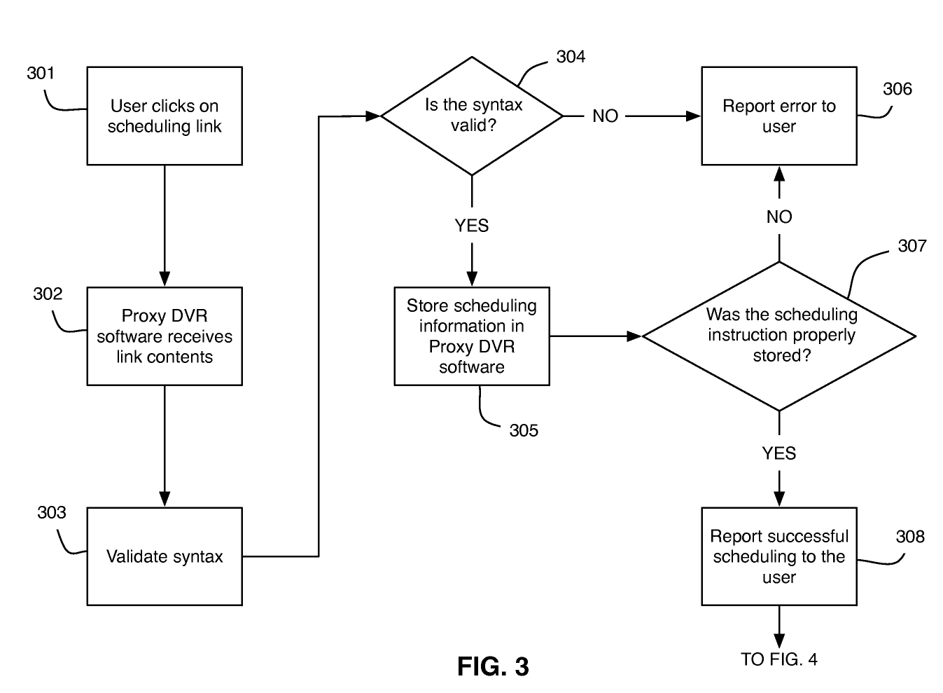

FIG. 3 is flow chart representing an alternative sequence of steps for implementing a proxy digital video recorder system 100. In step 301, a user may select a scheduling link component 103. As with the embodiment of FIG. 2, the scheduling link component 103 is preferably embedded in an advertisement or program guide, which may be displayed on, for example, a webpage or television-driven menu. A requesting user may select the link for scheduling by, for example, mouse-clicking on the hyperlink. However, in contrast to the embodiment of FIG. 2, the selection of the scheduling link component 103 preferably forwards the hyperlink contents to a local proxy digital video recorder 101 (rather than remotely over network 108 to a proxy digital video recorder 101). In step 302, the proxy digital video recorder 101 may intercept the scheduling instruction (as described above with reference to step 202), and in step 303, the proxy digital video recorder 101 may initiate syntax validation (utilizing link analysis component 106). As above, in step 304, any known method may be used to determine whether the syntax is valid. For example, the proxy digital video recorder 101 software instance may parse the information in the request packet to determine if any data corruption has occurred. Checksum, cyclical redundancy check, parity bits, and other known methods of error detection may also be utilized as required.

If the syntax of the request is determined to be invalid, then in step 306, the syntax error is preferably reported to the user. If the syntax is determined to be valid, then in step 305, the proxy digital video recorder 101 preferably stores the scheduling instruction. In step 307, the proxy digital video recorder 101 may determine whether the scheduling instruction stored successfully. If it did not, then in step 306, the error may be reported to the user. Otherwise, in step 308, success may be reported to the user, and the method may continue to FIG. 4.

FIG. 4 is flow chart representing a continuing sequence of steps for implementing the illustrative proxy digital video recorder system 100. In step 401, the proxy digital video recorder 101 may select a target digital video recorder 102 or 102a. Proxy digital video recorder 101 may be connected to and control the flow of scheduling instructions to multiple digital video recorder units 102 and 102a. This may be advantageous for users who wish to control how programs are stored on multiple digital video recorder units. For example, a user may wish for news broadcasts to be automatically sent to digital video recorder 102, and all comedy shows to be automatically sent to digital video recorder 102a. The sorting preference may be set within the proxy digital video recorder 101 (via, for example, a navigable graphical user interface). Subsequently, whenever proxy digital video recorder 101 receives scheduling instructions from the click of a scheduling link component 103, it may obtain genre or program type information, and send the scheduling instruction to the appropriate target digital video recorder 102 or 102a based on the stored user preference.

Once the target digital video recorder has been selected, then in step 402, the proxy digital video recorder 101 may determine whether the target digital video recorder comprehends the format of the stored scheduling instruction. As described above, different program providers may utilize different formats for their recording scheduling instructions. As a result, instructions from one provider server 107 may be unintelligible to a digital video recorder provided by a second provider server 107a. Therefore, if the target digital video recorder cannot understand the scheduling instruction format, then in step 403, proxy digital video recorder 101 may provide a translation service by parsing the contents of the original recording scheduling instruction and translating it into a format intelligible by the target digital video recorder. Then, in step 404, the translated scheduling instruction may be sent to the target digital video recorder. If the target digital video recorder does understand the scheduling instruction format, then in step 404, the original scheduling instruction may be sent to the target digital video recorder.

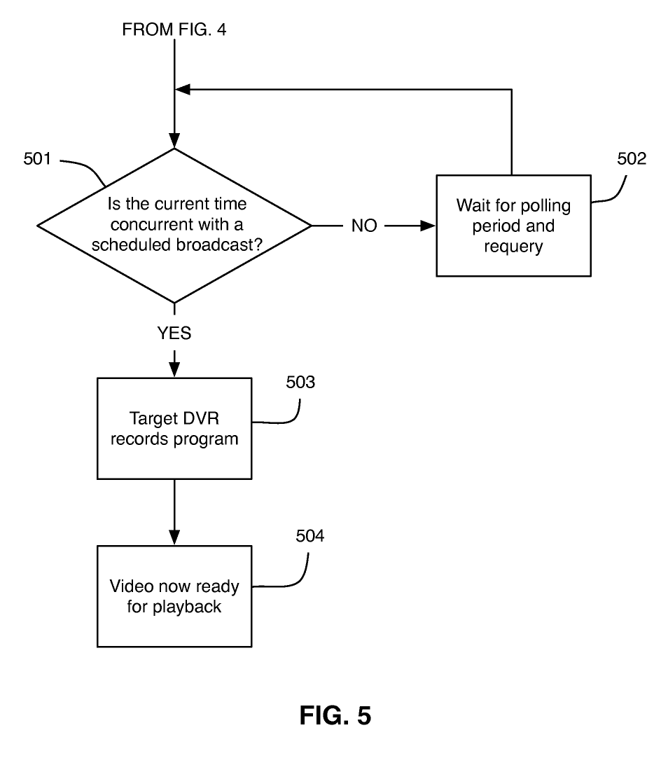

FIG. 5 is flow chart representing a continuing sequence of steps for implementing the illustrative proxy digital video recorder system 100. In step 501, the target digital video recorder may poll whether the current time is concurrent with a scheduled broadcast to be recorded. If it is not, then in step 502, target digital video recorder may wait for a polling period before querying again. If it is, then in step 503, the target digital video recorder may initiate recording of the broadcast program. Once recording is complete, then in step 504, the video may be ready for playback upon the user's instruction.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

1. A proxy digital video recording system, comprising:
a processor; and
memory comprising program instructions, wherein the program instructions are executable by the processor to:
intercept a request to record a video program, the request triggered by a requesting user and having a request format;
determine if a target digital video recorder can understand a format of the request; and
translate the request into an intelligible format if the target digital video recorder cannot understand the request format.

2. The system of claim 1, wherein the program instructions are further executable to:
receive a first user command indicating that video programs having a first characteristic are to be sent to the target digital video recorder;
receive a second user command indicating that video programs having a second characteristic are to be sent to a second target digital video recorder; and
automatically send the request to the target digital video recorder when the video program has the first characteristic; and
automatically send the request to the second target digital video recorder when the video program has the second characteristic.

3. The system of claim 1, wherein the request to record a video program is generated when the requesting user selects an embedded link on a website.

4. The system of claim 3, further comprising a scheduling component, the scheduling component comprising:
an identification component for determining the identity of the requesting user; and
a link analysis component for parsing recording instructions contained within the embedded link.

5. The system of claim 4, wherein the identification component determines user identification information.

6. The system of claim 3, wherein the embedded link contains broadcasting information, including at least a start time and a station identification.

7. The system of claim 3, wherein the embedded link contains program description information, including at least a title and an episode number.

8. A computer-implemented method for proxy-based digital video recording, the method being implemented on a computer system having a processor and memory, the method comprising:
intercepting with the processor a request to record a video program, the request triggered by a requesting user and having a request format;
determining with the processor if a target digital video recorder can understand a format of the request; and
translating with the processor the request into an intelligible format if the target digital video recorder cannot understand the request format.

9. The method of claim 8, further comprising:
receiving with the processor a first user command indicating that video programs having a first characteristic are to be sent to the target digital video recorder;
receiving with the processor a second user command indicating that video programs having a second characteristic are to be sent to a second target digital video recorder;
automatically transmitting with the processor the request to the target digital video recorder when the video program has the first characteristic; and
automatically transmitting with the processor the request to the second target digital video recorder when the video program has the second characteristic.

10. The method of claim 8, wherein the request to record a video program is generated when the user selects an embedded link on a website.

11. The method of claim 10, comprising:
providing a scheduling component, the scheduling component including an identification component and a link analysis component;
determining the identity of the requesting user with the identification component; and
parsing recording instructions contained within the embedded link with the link analysis component.

12. The method of claim 11, wherein the identification component determines user identification information.

13. The method of claim 10, wherein the embedded link contains broadcasting information, including at least a start time and a station identification.

14. The method of claim 10, wherein the embedded link contains program description information, including at least a title and an episode number.
